(19) United States
(12) Patent Application Publication
(10) Pub. No.: US 2011/0271187 A1
(43) Pub. Date: Nov. 3, 2011

(54) Musical Composition System

(76) Inventors: Daniel Sullivan, Shoreview, MN (US); Matt Cannon, Minneapolis, MN (US); Chad Koehler, Watertown, MN (US); Jason Nelson, St. Louis Park, MN (US); Michael Bergland, Plymouth, MN (US); David Weiberg, Minneapolis, MN (US)

(21) Appl. No.: 13/006,379

(22) Filed: Jan. 13, 2011

Related U.S. Application Data
(60) Provisional application No. 61/335,990, filed on Jan. 13, 2010.
(60) Provisional application No. 61/354,706, filed on Jun. 15, 2010.

(51) Int. Cl. G06F 3/16

(52) U.S. Cl. 715/716

(57) ABSTRACT

The invention herein concerns a system for permitting those with little or no musical training the ability to compose unique musical compositions from a variety of prerecorded loops. The loops can include sounds, musical phrases and the like and exist in various groupings designed to be compatible with one another in terms of key, beats per minute and musical style, such as, rock, blues or country. Where a loop is of a different grouping it can be easily and automatically modified in terms of pitch and tempo to be compatible with loops of another grouping.

### BACKGROUND OF THE INVENTION

Computer based tools that assist a composer in the writing and composing of a piece of music are well known. “Finale®” by MakeMusic, Inc. is an example thereof and is a powerful tool for notating, composing, editing and arranging musical works. This system was specifically designed for use by those possessing substantial musical skill and requires a significant investment in time to learn and use. A further compositional tool entitled “GarageBand®”, is designed and sold by Apple Inc. This software controlled system is easier to use than Finale, but still requires a great deal of musical sophistication to utilize fully.

A major problem with music compositional systems of this general type is the complexity of the graphical user interface. Naturally, that is a function, to a degree, of the complexity of the task at hand if one wants to provide for the ultimate in flexibility and breadth of scope regarding composing a musical work. Thus, it is necessary to have means for adjusting a host of factors, including; the individual notes, tempo, time signature and key, as well as the ability to arrange the work. These means of adjustment are typically achieved through a user interface wherein a time line is shown extending horizontally along the video display. The piece can be shown as written notes using standard music tablature and read from left to right and can also be shown graphically as a representation of the audio track.

With such compositional systems the user can also select from a wide range of prerecorded musical loops to create many layers of background sounds and/or accompaniments. It is also possible to play notes on an electronic keyboard having a MIDI connection to a computer running the system software where the played notes are heard audibly through the computer sound system and converted into written sheet music. This music can then be displayed in the user interface. The software can also permit changing of the “voice” of the notes played to emulate a wide range of musical instruments as well as provide for sound effects and background percussion and base tracks.

A complex variety of user operated virtual buttons or slides are typically included in the user interface and provide for insertion and use of the various effects, notes, loops, changes in time and key and so forth. These buttons can be arranged to simulate the look and feel of professional recording studio equipment. However, as indicated above, using this type of compositional software to produce a musical piece requires a considerable amount of musical ability. In addition, the user interfaces with all the different buttons, windows and pull down menus present a daunting obstacle even to the musically sophisticated person. Thus, a very considerable amount of study and work are needed to gain familiarity and fluency with existing music composition systems. Of course, for the average individual having little or no musical training there would be very little reason to even attempt to work with such systems. They would lack the motivation to consider composing a song in the first place, let alone use a software based composing system to do so. And, they would of course not have the requisite musical knowledge to tackle the considerable learning curve such compositional systems require.

Electronic keyboards are well known and also have the ability to produce a wide range of musical voices and sound effects. Many such keyboards can also assist a musician by playing percussion and bass accompaniments as well record their compositions. Electronic keyboard instruments are also known to include software that permits the transcribing of the notes played by the musician to standard tablature note and staff form. Again, such keyboards can provide significant assistance to a trained musician in creating and arranging musical compositions, but also present a very high skill and training hurdle to a musical neophyte.

Video games such as the “Guitar Hero®” and “Rock Band®”, series as developed and sold by Activision Publishing, Inc. and Harmonix Music Systems, Inc., respectively, allow a person having no musical skills or training the opportunity to simulate playing along with a prerecorded song. Thus for example, by pushing differently colored buttons on an instrument shaped controller in time with color matching “notes” scrolling by vertically from top to bottom on a video screen, an instrument part is played along with the background tracks of the selected composition. Of course, these pattern matching rhythmic games are not compositional in any sense as the entire musical content is fully prerecorded where the player has no ability to select other notes let alone create new compositions. However, more recent versions of the Guitar Hero® series, for example “Guitar Hero 5®” also includes a compositional component having a similarity to the aforementioned GarageBand® software. With this version of Guitar Hero it is possible to select among a wide variety of musical loops and styles. It is also possible to designate the key signature, the particular scale as to, for example, whether it is major, minor or blues. It also provides for the ability to play individual notes. The user interface includes, as does the standard Guitar Hero game play as discussed above, a vertically scrolling of colored dots or notes that correspond with the same colored buttons on the simulated instrument controller. It further includes virtual buttons that can be highlighted and selected by operation of the controller to select the various above stated compositional parameters and others. Although far less sophisticated than Finale® and GarageBand® and other compositional systems, this music studio ability of the Guitar Hero series of games still requires a user to have the motivation to work with and learn the user interface coupled with a reasonably sophisticated knowledge of music.

All of the aforementioned compositional systems also require essentially that the song be “constructed” along a time line in a piece by piece fashion where at least a melody must be fashioned note by note to which pre-recorded drum and bass tracks can be added. In other words, it is necessary to assemble the composition before it can be heard in its entirety. This approach is quite difficult for those having little musical training and or talent and it is a much more time consuming and difficult process.

It is known in music based video games, such as the aforementioned Guitar Hero and Rock Band, to display background animated graphics that coordinate with a prerecorded or user generated song during game play. Such graphics are shown typically as band members playing on various fanciful stage settings. These graphics are predefined animations that play repetitively during game play and therefore are quite limited in any ability to be changed during and in response to said game play.

Accordingly, it would be very desirable to have a compositional system that would be useable by those having little or no formal musical training or ability and that would also present a minimal learning curve for the user thereof. Specifically, it would be very helpful to have a compositional system where a musical composition is created in real time so that each part thereof is heard as it is selected and or created along with each and every previously selected or created part. In this manner it is much easier to know immediately how the composition sounds allowing immediate adjustments until the desired product is produced.

It would also be desirable to have a music compositional system that can be operated in a video game play manner so there exists a challenge and or entertainment value to the composing of a musical piece. It would also be desirable to enhance that entertainment value by being able to generate background graphics in real time response to the creation of the musical composition.

### SUMMARY OF THE INVENTION

The music composition system of the present invention includes musical compositional software for use with a suitable data processing device, such as, a personal computer or a video game console having audio and video capabilities as well as a controller connected thereto. The software provides for the representation on a video display of a first screen having a listing of a plurality of musical styles with each musical style heading having listed there under a plurality of stage files. A stage file consists of one or more bank sets and is designed to capture a particular style of music such as, rock, jazz, blues etc. Each bank set encompasses or is consonant with the style of its stage file and the other bank sets of that stage file. Each bank set has a plurality of individual banks each of which represents a basic component of a song such as its percussion, bass, rhythm, vocal and lead/melody loops or tracks. Each bank then includes a plurality of varying musical loops consonant with each other and with the loops of the other banks in that bank set. The loops within each bank are designed to work together with each other and with the loops of the other banks in the same bank set in terms of style, key signature and beats per minute. Thus, for example, the percussion bank would include a number of different drum loops all designed to work together with each other and with the loops in all of the banks in the same bank set. Each loop in a bank would comprise different versions or aspects of that bank where, for example, the bass bank would include different but compatible bass lines. The drum bank, for example, can have loops that vary in terms of the beats accented and in the type of percussion sounds and combinations of sounds as produced by a snare drum, cymbals, a high-hat and the like. The running time of each loop would also be the same, e.g. four measures or eight measures in the same time signature and at the same tempo.

The sounds can be either digital recordings of actual instruments or could be synthesized sounds and/or sound effects. Each of the percussion, bass, rhythm vocal etc. tracks or loops would be created to play in the same time signature and at a certain predetermined beats per minute rate. In this manner the loops of a particular bank would be fully compatible with each other and playable individually or together and the loops in each bank of a bank set would also be compatible with each other in order to form a pleasing total composition. The loops play continuously from the point in time they are initiated until the user stops them or the composition ends. A bank set then would consist of a number of banks, typically five, that are all created to be compatible with each other in terms musical key, beats per minute and style and where each bank consists of a plurality of loops. Thus, in the case of a bank set having five banks where each bank has five loops, there would be 25 loops total that could be selected where any combination thereof could play in synchrony with the others.

Certain stage files include banks that have one or more free form or one shot tracks. A free form track allows the user to play a plurality of preselected notes by activating one of a plurality of note playing switches on the controller. These notes are in the correct key and style of the particular bank set. In this mode the user is in full control of the timing of the playing of a note based upon when they push the button or buttons corresponding to that note. Where the bank is the percussion one, then the buttons may correspond to particular percussion components, such as, a snare drum, bass drum, high-hat or cymbal as opposed to a particular note. One shot tracks consist of sounds or a short sequence of notes or sounds that are used to provide a particular accent at one or more various points in the composition. Both free form and one shot tracks differ from the standard continuous loops discussed above in that they only play once, i.e. they do not continuously loop.

The banks of a particular bank set are presented on a video display in a linear fashion horizontally along the bottom perimeter thereof. The controller is used to move from bank to bank and to select loops within each bank where a color bar corresponding to each bank is highlighted to quickly indicate which bank is active, that is, in which bank individual loops can be selected and activated. Each loop also has a color bar or circle that is also highlighted when selected and activated. Once a loop is selected it instantly begins to play allowing the user to then select other loops to progressively build a composition and hear it as it is constructed.

All of the loops are controlled so that when initiated they are instantly audible and are in time with any previously selected loops thus requiring no special timing selection ability of the user. The user is also able to quickly switch between banks and can easily turn off a previously selected loop and activate other loops, i.e. any combination of the loops in the bank set can be selected to play and those selections can quickly and easily be changed as their composition progresses. Each loop that is selected is highlighted and can optionally include a further animated/pulsating graphic responsive to the volume and/or beat of the loop. As a result, the user can see which loops are active and can quickly and easily and with a modicum of study learn how to move between banks and activate or deactivate various loops. In this manner they can create unique musical compositions out of a wide variety of loop combinations and do so without any formal understanding of music or music theory. Those of skill will also realize that any particular loop need not be used during the entire composition, this is to say, any of the loops can be started and stopped during the composition giving the user a great deal of freedom to create an almost unlimited number of combination and permutations of loop selections. The software herein also provides for recording and saving of the composition.

The system herein also includes a studio mode where a bank in a particular bank set can be swapped out with other banks. This gives the user more creative flexibility to create many combinations of banks and greater creative freedom. For example, a vocal bank might be replaced with a rhythm bank. The studio mode also permits volume and pitch adjustment of each of the loops of the individual banks to permit further creative possibilities.

When a bank is swapped for another the invention herein includes software for easily adapting the new bank, if needed, to the pitch and beats per minute (BPM) of the bank being replaced. A software routine herein makes a calculation as between the musical mode of the selected bank and the bank and the mode of the bank it is to be substituted for. This calculation determines the half steps or semitones that the loops of the selected bank should be lowered or raised to be as compatible as possible with that of the bank it is replacing. The BPM data of the selected loop is also adjusted up or down to that of the replaced bank so the loops all play at the same rate. Thus, when a bank is substituted for an existing bank, the program will look at target key and tempo information accompanying each bank file and adjust the new bank appropriately so as to make a good musical fit without requiring the user to make this choice.

It will be appreciated that a novice would first begin by selecting a bank set of a stage file where none of the banks have a free form or one shot tracks, but could then progress to stage files having banks including such tracks. And, as their skills mature the studio mode can be selected providing an even further range of creative compositional possibilities in terms of selecting unique combinations of banks and adjusting the volume and pitch levels of individual loops. Thus, it can be seen that the compositional system of the present invention allows the creation of a composition in real time where all the parts are heard concurrently as they are added. Moreover, the user interface is easy to learn and operate allowing a beginner to quickly be able to create unique compositions. Therefore, the compositional system herein provides a user with a basic introduction to music composition that is easily grasped and managed and that can lead them towards the development of more advanced musical skills

A further advantage concerns the present invention's ability to create rich background graphics that are modifiable wherein they have the ability to adapt and change in accordance with the loops as selected by the user. The audio files of each loop are rendered with respect to various factors prior to being used in the game system. This pre-rendered audio meta-data is then used to drive the visuals accompanying the music that is the assembly of the various audio loops. By pre-rendering the audio data a substantial computational burden is removed from the microprocessor used in the computer or game system as compared to having that processor render the audio data and produce the display visuals based thereon in real time.

The present invention also provides for multiple users where two or more controllers are used by two or more users simultaneously. For example, each player can be assigned to a particular bank to control the selection of loops therein. Where this has particular application is where multiple players are each assigned to a particular free form bank. In such case, one user may handle the percussion, one the rhythm and so forth. In this manner multiple players could comprise a “band” and create a composition cooperatively as individual players of a particular instrument.

The composition system herein also allows the user to download additional bank sets from a website as well as upload their composition to a website designed to share their compositions. Their compositions can also be output or saved as MP3 files.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a diagrammatic representation of the compositional system of the present invention

FIG. 2 shows a detailed view of a controller for use in the system herein.

FIG. 3 represents a view of the game play mode screen.

FIG. 4 represents a view of the studio mode screen.

FIG. 5 represents a view of the loop volume and tempo adjustment screen.

FIG. 6 represent a view of the performance mode screen.

FIG. 7 shows a representation of a portion of a piano keyboard.

### DETAILED DESCRIPTION

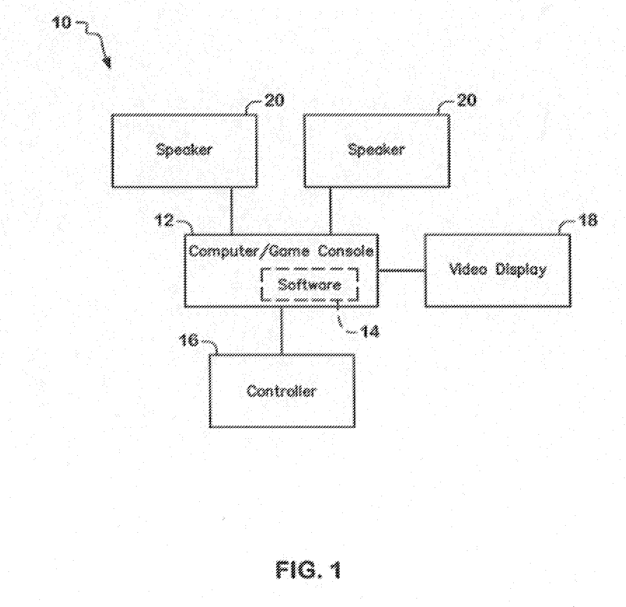

A schematic view of the musical composition system of the present invention is seen in FIG. 1 and generally referred to by the numeral 10. As seen therein, a computer processing device 12, such as a personal computer or game console, is used to run proprietary compositional software 14 of the present invention that is loaded therein. As is understood in the art, a controller 16 is used to control the operation of the software 14, particularly when using a game console, and optionally with a personal computer wherein a keyboard thereof, not shown, can be substituted therefore. The controller 16 can be an electronic piano keyboard, a game controller or other device having the appropriate number of control switches to provide for the appropriate inputs as is required by control software 14. As is understood in the art, the controller can be designed to simulate the shape and appearance of a wide variety of musical instruments, such as a guitar or other stringed or woodwind instruments. A video display 18 and a loud speaker system 20 are connected to or form a part of computer 12 and provide the user with the visual and audio outputs of the present compositional system 10. Of course display 18 combined with controller 16 is required for the user to operate system 10 as will be described herein below in greater detail.

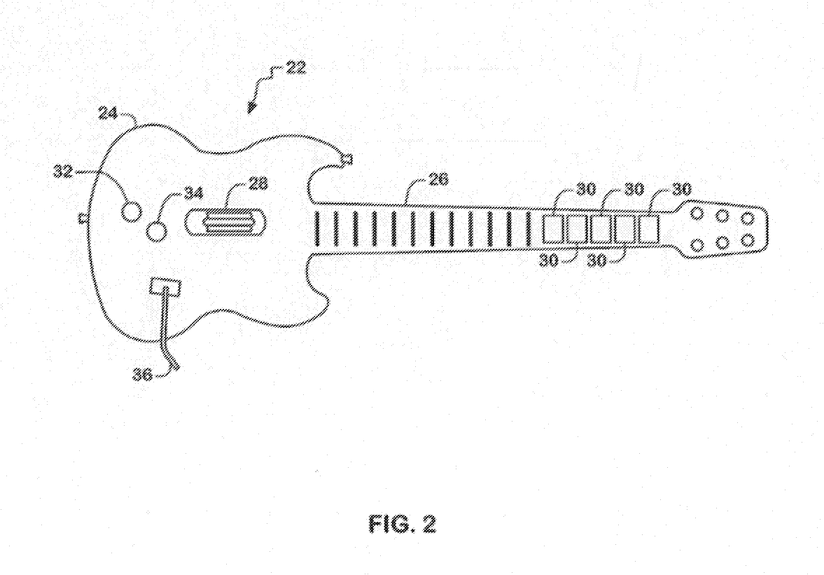

As seen in FIG. 2 a particular controller 22, well known in the art, is shown and is of the type used by the Guitar Hero® and Rock Band® video games. Controller 22 is shaped to emulate a guitar and includes a guitar body 24 and neck 26. A strum bar 28 is a two position switch operable to up and down positions. Five differently colored fret buttons 30, typically green, red, yellow, blue and orange, extend along neck 26. Body 24 includes a start button 32, a select button 34 and a simulated “whammy” bar control switch 36.

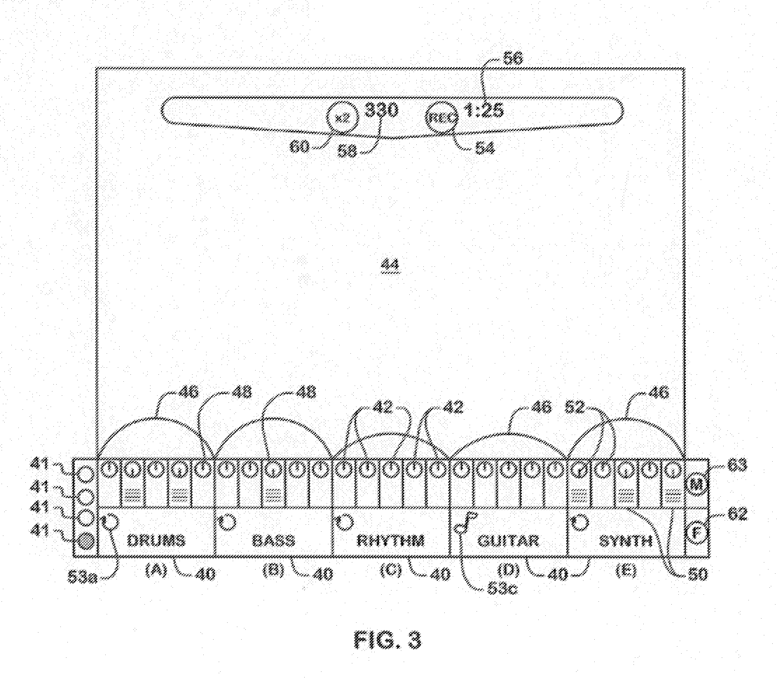

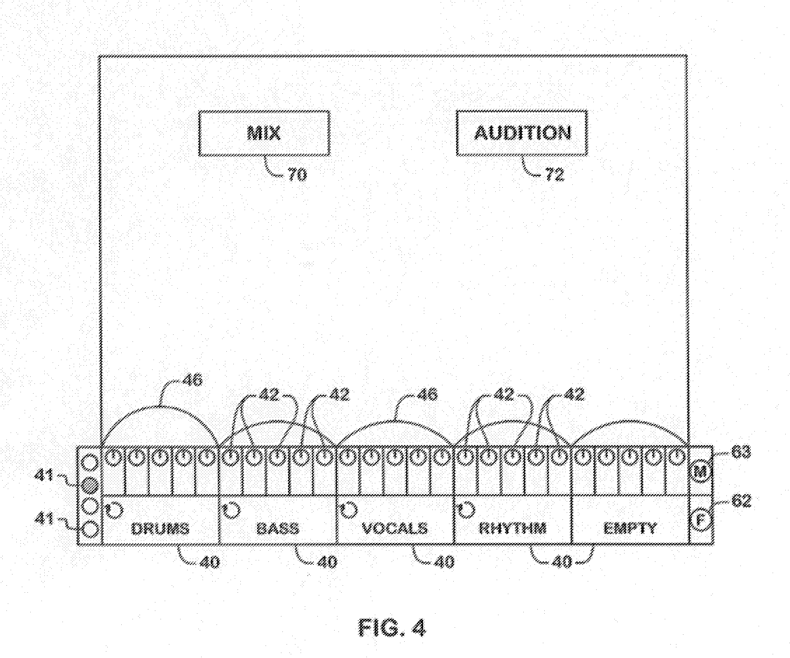

At an initial menu screen, not shown, the user is given the option, by using controller 16, to select between, a “Jam” button where the user is taken to the standard game play screen, seen in FIG. 3, a ‘Studio Mode” button where the user is taken to a studio mode screen, as depicted in FIG. 4, a user composition button that takes the user to a listing of previously composed pieces as saved by the user, an option button which then permits the user to select between various graphics, controller and volume adjustment options and the like, and an “Exit” button to exit the program.

In the standard game play mode as seen in FIG. 3, a plurality of banks 40 are displayed horizontally along the bottom of the display screen 18. Each bank includes a plurality of loops 42 also displayed horizontally. In the preferred form there are 5 banks 40, identified as A, B, C, D, and E wherein each bank has five loops 42. The five banks 40 thus comprise a bank set of 25 loops 42. These banks 40 and loops 42 are all prerecorded and are created to work together musically and stylistically. The banks 40 each comprise components of a composition, such as, the drums, bass, rhythm, guitar and synthesizer tracks as indicated. The loops 42 of each bank 40 comprise different subsections thereof. Thus, for example, the bass bank can include five different bass line loops. A percussion bank can then include, for example, loops that each have a different percussion sound or groups of sounds as well as different accenting. A stage file consists of a plurality of bank sets where, for example, four bank sets would include 100 loops. A stage file represents a certain musical genre and style in that the various bank sets are similar and compatible.

The lowest level of this musical hierarchy is a loop, which is defined as a sound file. These can be played as 44 khz stereo .WAV files wherein the compression format on the hard drive, not shown, of the computer 12 can be OGG. The length of these files can be fixed at 1, 2, 4, or 8 bars or measures, though other numbers will be allowed in integer increments. In order to permit the widest degree of compatibility between banks, constraints can be placed on the playback tempo and music key. The playback tempo is generally fixed at either 80,100,120,140,160 BPM and the playback key is fixed at C, G, E and A and the relative minor keys thereof. Each loop also has an associated text file that helps to enable sorting into categories for easy selection/substitution of banks or loops. The information from the text files is used to display menu selections and labels. It is not necessary to have a predetermined set of labels since the program will populate the selection menus with the text that it pulls from the loops, banks, or stages.

Other key signatures and BPM are possible but it is desirable to minimize the pitch shifting and time shifting. In such cases though a tempo/key conversion program can be used to stretch the loops and pitch to help banks of one stage file be compatible with those of another stage file as is described herein in greater detail below.

If the standard game play mode is selected the user is first taken to a library screen of all the available stage files, previously save user compositions or mixes. At this screen the user can select there between in order to populate the banks 40 in the standard play mode. Stage files are labeled with a name that may describe or indicate the musical style thereof, such as, “Blues II”, “Techno Pop 3”, and the like. If the stage file includes for example, four pre-defined bank sets one will populate the five banks 40 and the other three will be loaded as well. Color indicator buttons 41 will indicate by highlighting which of the four bank sets is currently loaded into and populating banks 40. During game play, by use of the whammy bar 36, the user can switch between the bank sets of the stage file, that being four different bank sets in this example. As seen in FIG. 3, after the individual banks 42 are populated, the appropriate graphics labels appear and identify each bank as percussion, bass, etc. The user then operates a controller 16 to first select between the individual banks 40.

During the creation of a composition the user may select all the loops 42 of a particular bank 40 or just one, that being completely up to their artistic discretion. A further advantage of the present invention is that the user is not required to pay attention to issues of timing as to when they select a loop 42. In other words, they do not have to activate a loop in time with the other loop or loops 42 as that is done automatically. This result is accomplished by the fact that as the bank sets are loaded from a stage file, all the loops thereof are initiated in synchrony at zero volume. Thus, when the user activates a loop the software un-mutes that loop, i.e. brings it to a predefined non-zero volume. In this manner, regardless of when the loop 42 is activated, it is completely synchronous with the other loops 42 of the stage file. Timing selection however is a factor in the scoring of game play as will be further described herein below.

Referring again to FIG. 3, the game play mode is shown and includes an upper animated graphics stage portion or screen area 44 where various user selected animations are displayed and which respond in different ways as the various loops 42 are selected and played. Five banks 40 extend along the bottom of the display and are color coded by “arming” tabs 46 that preferably match the colors of fret buttons 26 of controller 22. Each bank 40 includes five loops as indicated by similarly colored dots 48. To activate a bank 40 strum bar 28 is operated in the up direction while the fret button that matches the color of the bank tab 46 is depressed. The corresponding tab 46 is then activated where the color thereof is highlighted and or it is enlarged in size as is represented in FIG. 3 with the banks labeled “Drums”, “Bass” and “Synth”. The loops 42 of the selected bank 40 can then be activated by downward movement of the strum bar 28 combined with the simultaneous pushing down of a fret button 26 that matches the color of a loop button 48. The selected loop 42 then begins to play. Each of the colored buttons 48 so selected is also highlighted and enlarged. In addition, further animated graphics 50 such as a wave form or the like can be activated below buttons 48 to further indicate to the user that the particular loop is activated and playing. Moreover, those of skill will understand that the graphical animations 50 can be made to pulsate in synch with the volume and/or beat of the loop track as it is played.

Each button 48 further includes a rotating clock arm 52. Arm 52 rotates clockwise through 360 degrees from a 12:00 o'clock position and back thereto. Each 360 degree clockwise rotation coincides with the duration or length of the selected loop 42. As seen by referring to both FIGS. 3, 4 and 6, a circular arrow symbol 53a indicates that the loops 42 of a particular bank 40 are continuously repeating. A downward pointing arrow 53b indicates that the loops 42 of that bank are of a “one shot” variety, i.e. a sound effect or sequence of sounds or notes that just plays once. These loops 42 can be used for particular effect at various points in the composition. Where the loops of the bank are free form a note symbol 53c is used to indicate that a particular note or sound is being played. Where a bank includes both continuous loops and a free form track and/or a one shot track then a further symbol 53d is used and is a combination of the continuous loop symbol 53a and the downward pointing one shot arrow 53b.

The user can move to another bank 40 by pushing down a different fret button 26 while moving the strum bar 28 up. The tab 44 of the previously activated bank 40 remains highlighted if one or more loops 42 thereof remain active. The previously activated loop or loops 42 will continue to play and a further loop or loops 42 can then be selected in another bank 40 and activated and layered on top thereof by use of the strum bar switch 28 and fret buttons 26 as with the previous bank 42 by pushing down on the strum bar 28 while depressing a fret button 26 for a particular loop. If more than one loop 42 is desired to be initiated in a particular bank 40, the user needs only to push down on two or more of the fret buttons 26 while operating the strum bar 28. A loop can be stopped while in an active bank by pushing down on the strum bar 28 while not pushing down on that loop's correspondingly colored fret button. If another loop 42 in that same bank 40 is desired to be kept playing then its corresponding fret button 26 needs to be held down. In this manner it can be seen that the user can easily move back and forth between banks 40 and activate any combination of the twenty-five loops 42 in that bank set.

It is important to note that the composition is assembled in real time where the user can hear the results of what they are doing immediately. That is, all selected loops 42 are playing simultaneously. This is very important for most individuals as it is very difficult to put together parts of a composition one part at a time without knowing how they sound in a full context of all the various musical components. Those of skill will now understand that a person of limited musical ability can easily and quickly assemble a composition of uniquely combined loops by simply moving between banks 40 and selecting loops 42. Also, a record button 54 can be activated as the composition is being assembled or thereafter to record the composition. A timing graphic 56 counts out the length of the composition as it is being recorded. An interesting feature of not having a timing constraint with regard to the activating of a loop 42 is that the user has a wide degree of freedom in assembling the sequence of selection of loops 42. In other words, a particular loop 42 in, for example, a percussion bank can play for a part of the composition and be exchanged for another percussion loops at another point therein. Moreover, this transition can be done quickly and need not coincide with the end of a loop 42 as indicated by timing arm 52 but could be initiated at any time within the loop. Thus, using musical terms, the initiation is not tied to the beginning or end of a musical measure, thereby creating an additional level of creative opportunity.

In the game play mode as represented by the standard composition interface of FIG. 3, timing of the selection of a loop can come into play with respect to game scoring. Clearly, the present invention provides an easy entry point for a person of little or no musical training or skill with a way of putting together a unique musical composition regardless of any “game” play aspect. However, a game play aspect can be introduced to motivate the user further to play with the composition system herein. Scoring points permits movement to or through various levels where, for example, the user is rewarded with the ability to unlock and use additional stage files and gain access to the banks and bank sets thereof. These bank sets can increase in difficulty by, for example, operating at faster tempos and/or using one or more free form banks.

Those of skill will recognize that scoring of the “quality” of a composition would be problematic. Thus, scoring is based on objective criteria, such as, were the loops 42 selected “in time” with the other loops 42 of the same bank or other banks. As stated above, all the loops are synchronized regardless of the timing selection of the user, however, the software can determine if the initiating of a continuously repeating loop 42 is done at, or within a close tolerance of the “beat” of one or more other previously selected loops. Thus, for example, if the time signature of the loops 42 is 4/4, that is, four beats to a measure with a quarter note representing one beat, a score is given if the loop is initiated within a certain tolerance of the start of each measure thereof, i.e. one chance every four beats. One shot and free form loops are scored if they are initiated within a tolerance of any beat thereof, e.g. any one of the four beats in a 4/4 time signature, however these loops are scored lower than correctly initiated continuous loops. Other objective criteria can include an increase in points for the use of free from notes and/or the correct timing of the initiation thereof, an increase in points for attainment of a certain level of composition complexity in terms of range of loops 42 used in the composition and/or as a function of the activation and deactivation thereof with a corresponding loss of points for exceeding a predetermined complexity level which may be indicated by too many loops activated for a predetermined period of time and/or too high a total of loop activations and deactivations occurring during a predetermined period of time and/or during the entire length of the composition. A scoring graphic 58 indicates what the user's score is and a multiplier graphic 60 indicates if the scoring is being multiplied, e.g. one times (1×), two times (2×) etc. The multiplier is reduced or lost when no loops are activated after a predetermined period of time has elapsed. This prevents the user from accumulating the points without interaction. A fade button 62 allows the user a means of ending the composition by fading it to an end point. The composition can also be stopped by operating the controller 26 to select the menu button 63.

At the end of play the user is first queried if they want to save their composition and subsequently in a separate screen the total score is shown for the composition. A user filled box permits the user to give a unique name to their composition. In this same screen the score can be added to or increased by an achievement score that can be a function of, for example, how many saved compositions they have and/or the number of saved compositions that have achieved a certain predetermined total score.

The studio mode user interface is seen in FIG. 4 and differs from the standard game play mode user interface in that it does not have the animated graphics in area 44. In fact, compositions can not be constructed and played in studio mode. Studio mode provides for a way of customizing a ban set prior to composing and/or game play. Thus, the purpose of the studio mode is to allow advanced users more control over a particular set of banks by allowing them to customize each of the loops in each bank thereof and to swap banks from the existing bank set with banks from other bank sets of the same stage file and even from other stage files. When the studio mode is selected at the main menu screen the user is permitted to select whether they want to choose the available stage files or from a template file. If the user chooses stage file then they will be presented with a pull down window listing the various stage files from which they can highlight and select the desired one. The selected stage file will populate the banks 42 with one bank set thereof and with others as previously described for the standard compositional mode.

If the template option is chosen then a pull down menu provides choices of differently named and described templates, e.g. “slow blues 3” or “dark metal 2”. Each template is empty in the sense of having no bank sets. However, the templates include a set key and tempo that is evocative or a style and or “mood” of music. Thus, when a template is selected the user must populate each bank individually and each bank, if necessary, is automatically adjusted by the software to fit the key and tempo criteria of the template thereby permitting the user to ultimately create a composition in that template musical style. A more detailed description of this software adjustment process in set out below.

At the studio mode screen of FIG. 4, there exists a “Mix” button 70 and an “Audition” button 72. Selection of the Mix button 70 allows the user to select an arming tab 46 of a particular bank 42 after which the user is presented with the option to change/select a bank or adjust loop volume and pitch. In this case where the template option has been chosen, there would be no loops to adjust so the user will choose the select bank option and will be presented with a bank selection filter menu. Two pull down menus allow the user to first select as to musical genre, rock, pop, country, etc. and then as to bank type, i.e. guitar, drums, vocals and the like. A final pull down menu lists the bank or banks that fill the selected filter criteria from which the desired bank can be selected. This procedure is repeated until all the banks are populated. Various loops 42 can also be activated, however no sounds will be generated. The audition button 72 provides a quick way for the user to hear what they have selected so far. However, to actually use the selected banks to create a composition the user must first exit the studio mode, save the particular mix/bank set. The user can then open the standard play mode and select this created bank set or mix from the user files comprising compositions or any such mixes they have previously saved.

If the user selects the option to choose from the existing stage files a pull down menu will provide a listing thereof from which a selection can be made. If the stage file has more than one bank set the one will populate the banks 40 and the others will be loaded a previously described. Selection of mix button 70 permits the user to swap an existing bank for another or adjust the volume and pitch of each of the loops 42 thereof. Thus, selection of a bank tab 46 will open a screen that allows the user the option to swap out that bank for another or adjust the pitch and volume of the loops 42 thereof. If the user selects the bank swap, pull down menus are presented that can be used to filter or narrow down the number of banks by criteria such as genre of music, e.g. rock, country, blues, etc. and/or by functional category, such as, drums, guitar, bass and the like. Once a bank is chosen a select button can be activated to replace the existing bank 40 with the newly selected one. Selecting of that bank again allows the user the option of swapping out that bank for another or adjusting the volume or pitch of each of the loops thereof.

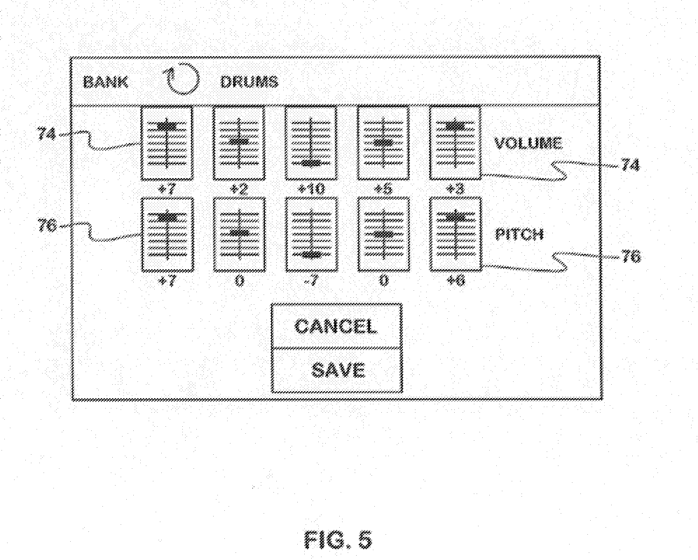

Selection of the adjustment option, as is represented in FIG. 5, shows each of the five loops 42 represented by a simulated pair of same colored slider volume switches 74 and pitch switches 76. The controller 22 is used to move the switches 74 and 76 up or down to adjust each loop 42 accordingly. The pitch can be adjusted up or down one octave and can be adjusted there between. Thus, the user has the ability to effect a somewhat atonal sound if desired. The user is then given the option to accept or reject those changes. When in the studio mode after a bank 40 has been loaded and a loop 42 selected the Audition button 72 can be selected to permit the user to listen to the selected loop or loops 42 as such is not permitted in the studio mix mode. The audition mode does not permit recording but simply allows a quick way to hear what has been selected in the mix mode. The studio mix mode only permits the customizing of a bank set and the loops thereof which mix can then be saved. When completed the mix can be saved and then subsequently be selected for play in the standard game play mode. The ability to swap banks and adjust loop volume and pitch is also available when a template is started with rather than a stage file.

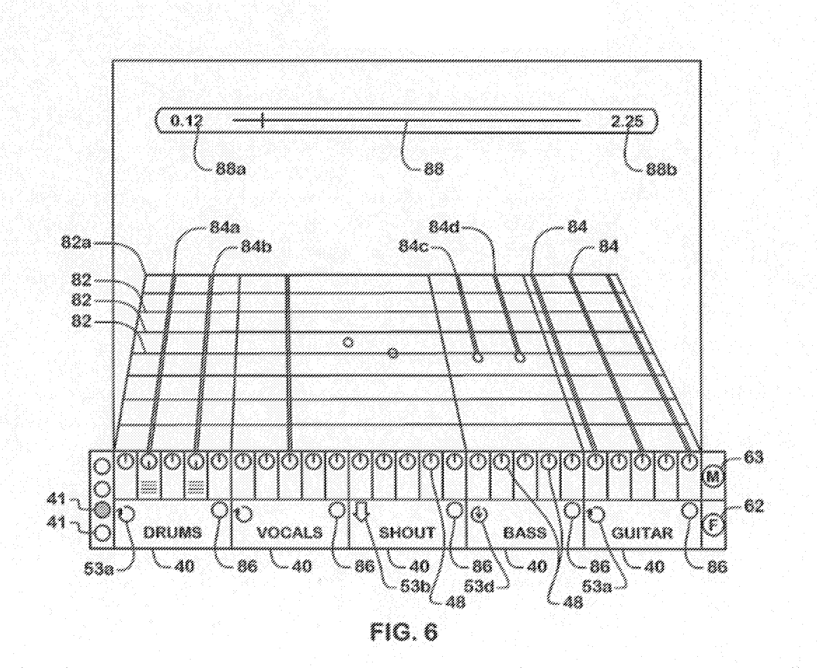

A performance mode is represented in FIG. 6 and permits the user an ability to see an animated graphic of the playing of the loops of one of their compositions that has been previously saved. When they select a composition from their personal library they are given the option to load it into the game play mode or the performance mode. As seen in FIG. 6, the performance screen shows the five banks 40 with the difference being the horizontal lines 82 there above. The vertical lines 84 represent the selected loops 42. This display of selected loops is animated and scrolling from the top down, that is, from horizontal line 82a towards banks 42. The lines 84 that have scrolled down and “reached” their correspondingly colored loop dot 48, as represented by for example, lines 84a and 84b, are activated and playing. Lines 84c and 84d have not reached their corresponding dot 48 but show that such loops will be activated as the animation continues and they meet such dots 48. Dots 85 is indicative of the fact that these associated loops in the bank labeled “Shout” are one shot sounds. Thus, to differentiate one shot and free form tracks in the performance mode circular dots 85 alone are used as opposed to the continuous loops that that are represented by lines 84 that are comprised of a dot and tail portion. The rate at which the loop activation animation scrolls is a function of the beat per minute rate. The menu button 63 permits the user to pause the scrolling at any time, also each bank 40 has a record button 86 that when activated mutes or cancels any current or yet to occur activations of any of the loops 42 of that particular bank 40. With the record button 86 activated the user can then select any one or more of the loops as in standard game play and modify their composition accordingly. Turning off the record button reverts to the original composition so that and activations or deactivations of the loops 42 that occur after the newly amended section will occur as previously recorded. A time bar 88 indicates the position in the recording and includes a time elapsed graphic 88a and a total time of the composition 88b. Thus, the performance mode allows the user to visualize the sequence of the loop activations of their composition and to make changes thereto.

When a composition is completed and saved the user is given the option to export it and save it as an MP3 file. Users can also upload the file to a website designed for users of the compositions system of the invention herein so that others using said system can play the compositions of others. The uploaded compositions can also be rated/scored by other users wherein that score can be used to augment their internal score and/or to give prominence on the website lists of downloaded compositions. The website can also provide for the downloading of additional stage files.

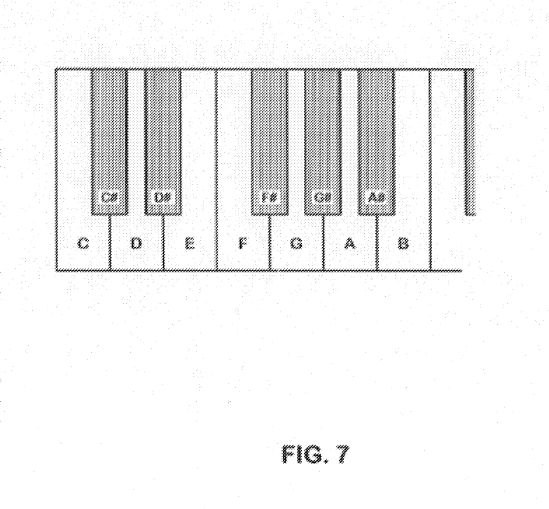

When a source bank 40 or loop is loaded into a target Bank the source bank or loop will automatically adjust, if necessary to match the beats per minute BPM and the pitch/key of the bank set it is going to be transplanted into. For an understanding of how this pitch adjustment is accomplished it is helpful to look at the representation of a portion of a piano keyboard as depicted in FIG. 7. As is well understood by those of skill, Western music is typically composed from a set of 12 notes. These 12 notes are often referred to as the “Chromatic” scale. In FIG. 10 a chromatic scale shows those twelve unique notes marked as; C, C#, D, D#, E, F, F#, G, G#, A, A#, and B. As is also well understood, music is typically written in a particular key comprising a scale of seven of the twelve notes. In the key of C-major the scale associated therewith is comprised of the seven notes C. D, E, F, G, A and B wherein C is the root note. There are seven modes that can be generated from each seven note key scale which share identical notes with each other depending on the root note of the key in which a musical piece is written. The modes are named as follows; Ionian (a/k/a. Major), Dorian, Phrygian, Lydian, Mixolydian, Locrian, and Aeolian (a/k/a Minor). In the C-major scale where C is the root note, each of these mode scales thereof can be played using all white keys, i.e. all the notes of the C-major scale. Thus, the Dorian mode scale of C-major has seven notes but starts with D and is played D, E, F, G, A, B and C and in the Phrygian mode the scale starts with E and is played E, F, G, A, B, C, and D. Thus, in all the modes of a particular scale all the notes are the same with the only difference being the note that the mode scale starts with. Thus, each seven note scale corresponding to a particular key has six closely related musical “cousins” which share the same notes. Songs written in keys other than C include sharps and flats as do all the modes of each of the other non C-Major keys. For example, in the key of E-flat the notes of the Aeolian mode scale include all the notes of the E flat major scale where C is the starting or mode root with the notes of that mode scale played in the order: C, D, E flat, F, G, A flat, B flat. This scale is also referred to as the C-minor scale and is closely related to all the other mode scales of E flat major as well as the E flat major scale itself. Thus, if loop is written in C-Minor it could probably be used pleasingly with a bank set written in E-flat Major as the notes used are the same but for the fact that the major scale and mode roots would be different.

To shift the pitch of a sample loop to that of a target loop to provide for an overall musically aesthetically pleasing transplant of one into the other the software herein uses an equation to calculate what amount or number of semitone steps the former must be moved up or down to match the latter. The equation requires the semitone offset of the sample and the target as well as the semitone offset relating to the key of the source and target. The semitone offset of the particular mode of each is found in table A below.

TABLE A

| | Semitone |
|---|---|
| Mode | Offset |
| Aeolian | 0 |
| Locrian | 2 |
| Ionian | 3 |
| Dorian | 5 |
| Phrygian | 7 |
| Lydian | 8 |
| Mixolydian | 10 |

The semitone offset of the key of the source and target are contained in table B below.

TABLE B

| | Semitone |
|---|---|
| Key | Offset |
| A | 0 |
| A# (Bb) | 1 |
| B | 2 |
| C | 3 |
| C# (Db) | 4 |
| D | 5 |
| D# (Eb) | 6 |
| E | 7 |
| F | 8 |
| F# (Gb) | 9 |
| G | 10 |
| G# (Ab) | 11 |

With these data it is then determined how many semitones the sample needs to be shifted to sound appropriate in the target context. That is done using the equation n=(Kt−Ks)−(Mt−Ms), wherein:

Kt is the Target Root Key Semitone Offset Value from Table B.
Ks is the Source Root Key Semitone Offset Value from Table B.
Mt is the Target Root Mode Semitone Offset Value from Table A.
Ms is the Source Root Mode Semitone Offset Value from Table A.
Some examples of the results from this equation are set out below in Table C.

TABLE C

| | | Equation | (partially | Result |
|---|---|---|---|---|
| From Sample | To Target | (Kb-Ka)−(Mb- | solved | (semitones to |
| Key—Mode | Key—Mode | Ma) | equation) | transpose) |
| D—Dorian | A—Aeolian | (0-5)−(0-5) | (−5)−(−5) | 0 |
| D—Ionian | A—Aeolian | (0-5)−(0-3) | (−5)−(−3) | −2 |
| C—Aolian | A—Aeolian | (0-3)−(0-0) | (−3)−0 | −3 |
| C—Ionian | A—Aeolian | (0-3)−(0-3) | (−3)−(−3) | 0 |
| E—Phrygian | C—Ionian | (3-7)−(3-7) | (−4)−(−4) | 0 |
| F—Phrygian | C—Ionian | (3-8)−(3-7) | (−5)−(−4) | −1 |
| F—Phrygian | D—Ionian | (5-8)−(3-7) | (−3)−(−4) | −1 |

By adding or subtracting 12 from the Result of the equation in FIG. 11, it can be determined if there is a potentially better alternative to the result. If the result to transpose is +7, then from a whole octave perspective the semitone offset could also be −5. In other words, the same result would be reached in each case except that the latter would be in a lower octave. Therefore, it is also possible to add twelve to the above equation result and select the result that is closest, in an absolute value sense, to zero. After adding or subtracting 12 from the result, the final result we choose will be the result closest to 0. This is done primarily because applying pitch shifting that results in the least pitch change generally produces more undesirable audio artifacts in the resulting audio, so the value closest to 0 is generally the more desirable.

The software herein also performs a tempo shift which is calculated by determining the source and target beats per minute (BPM) of the source and target loops. For example, if the source loop is 120 BPM and the target tempo is 60 BPM then the source loop is increased 200% in length, or for a 90 BPM target where the original sample is at 120 BPM, the original sample is decreased in length by 33%. In the present invention each loop is tagged with proper mode and tempo identification making it possible to take musical loops that were created in one context and transplant them into a different musical context with reasonable chance for a pleasing result.

Each loop 42 comprises audio data that can be rendered to produce meta-data to drive audio visualizers. This pre-rendering greatly reduces the computational burden that would be placed on the microprocessor capacity of the applicable computer or game console running the software herein as compared to attempting to render the audio data and generate video based thereon in real time. Using this pre-rendering approach the game software herein can create a richer and more interesting graphical game environment.

This pre-rendered audio meta-data data contains information gathered from detailed analysis of the audio signal with respect to such factors that include, but are not limited to, pitch, transient, spectrum, amplitude and speech analysis. Those of skill will realize that many types of data analyses can be run which data generated there from can then be fed into visualizers to create pleasing visual effects. An analysis tool is used that consists of algorithms that analyze each loop. Those of skill will understand that a wide variety of algorithms can be devised to look for particular types of audio data or event signatures, such as energy level, bass drum kicks, certain music pitch, and the like. In the present case, each loop is in the open source audio format .ogg having 0 to 32 channels, each channel corresponding to one type of algorithm analysis. The meta-data curves are grouped based on a particular bank set or stage file and stored in the data directory of the game software. When a stage file, for example, is selected and loaded, all of the corresponding meta-data curves for that stage are also loaded into the audio engine thereof. The data in those curves is accessed for a specific point in the playback of the corresponding audio loop .ogg files using functions that sample the curve data based on the stage file type and returns the sum, max, or average of the data for all the currently playing .ogg files of the particular stage file. The meta-data so generated is generally reviewed manually as it is understood that the algorithms may not analyze the audio data correctly and human intervention is often needed to “scrub” the data to produce a desired clean data result.

The graphical data is generated by suitable 3D generating graphic software, such as 3D Artist Studio Max™ to generate the 3D mesh. Other software, such as Photoshop® can be used to create the surfaces and textures. Before selection of a particular stage file the game user can select from a plurality of venues. The venues are composed of various 2D and 3D graphical elements that comprise the environment in which the game is played. Each venue includes a wide plurality of “Gadgets” or graphical shapes or figures that respond to the audio meta-data. Thus, as is well understood, a gadget can consist of a shape, such as an orb, that may respond to one or more of the meta-data curves generated from the one or more algorithms. Thus, the orb may be programmed to respond to a bass kick to pulsate with each kick and/or to rise higher based on the volume of the sum of all the selected loops. Other gadgets can then be designed to respond to other meta-data information. Thus, the gadgets poll the meta-data curves based on the properties of the gadgets as determined using an editor, such as Tool Bench® as developed by Emergent Game Technologies. Various game creation software exists to prototype and develop game software, such as, GameBryo® Lightspeed™, also by Emergent Game Technologies.

What is claimed is:

1. A musical composition system comprising:
a microprocessing device,
a display device connected to the processing device,
a controller connected to the processing device,
an audio playing system receiving audio signals from the processing device and for audibly outputting the audio signals,
software running in the processing device for coordinating the operation of the controller, the display and the output of audio signals wherein graphics are shown on the display that can be interacted with by a user by means of the controller and where in a compositional mode the display shows a graphical user interface having a plurality of banks, and each bank having a plurality of prerecorded loops associated therewith, each loop being a sound recording representing the playing of musical notes or the playing of sounds, any one or more of the loops being selectable by a user by operation of the controller to initiate the playing of the loops and outputting audibly the playing thereof.

2. The system of claim 1, wherein each loop as selected begins to play audibly in a manner that is in time with any other musical loop selected there before.

3. A method for synchronizing the timing of the playing of a plurality of musical loops comprising the steps of:
initiating the playing of the plurality of loops at a common zero time wherein the loops are all being played in synchrony and at zero volume,
selecting one or more loops and raising the volume of each one or more loop as it is selected.
